(19) United States
(12) Patent Application Publication
(10) Pub. No.: US 2014/0184008 A1
(43) Pub. Date: Jul. 3, 2014

(54) BRUSHLESS DIRECT CURRENT (BLDC) MOTOR

(71) Applicants: HYUNDAI MOTOR COMPANY, Seoul (KR); KIA MOTORS CORPORATION, Seoul (KR)

(72) Inventors: Dong Myoung Ryoo, Yongin (KR); Bu Yeol Ryu, Hwaseong (KR); Pil Seon Choi, Anyang (KR); Bo Sung Lee, Daejeon (KR)

(73) Assignees: KIA MOTORS CORPORATION, Seoul (KR); HYUNDAI MOTOR COMPANY, Seoul (KR)

(21) Appl. No.: 13/858,395

(22) Filed: Apr. 8, 2013

(30) Foreign Application Priority Data
Dec. 27, 2012 (KR) 10-2012-0154112

(51) Int. Cl. H02K 1/27

(52) U.S. Cl. CPC H02K 1/27
USPC 310/156.22

(57) ABSTRACT

A brushless direct current (BLDC) motor includes a magnet which includes N poles and S poles extending in the up-down direction. The N poles and S poles are arranged to alternate with each other, surround an exterior of a shaft, and have a cylindrical shape when assembled. The magnet has upper and lower tapered portions in upper and lower portions thereof, with the diameter decreasing in the direction toward opposite ends, and a fixing center groove formed in the middle thereof. Fixing caps respectively have inclined portions at positions corresponding to the upper and lower tapered portions of the magnet so that the tapered portions fit into the inclined portions, thereby fixing an axial position of the magnet. A center ring is fitted into the center groove of the magnet in order to prevent the magnet from being dislodged while a rotor is rotating.

### CROSS-REFERENCE TO RELATED APPLICATION

This application claims under 35 U.S.C. §119(a) the benefit of Korean Patent Application No. 10-2012-0154112 filed Dec. 27, 2012, the entire contents of which are incorporated herein by reference.

### BACKGROUND OF THE INVENTION

1. Field of the Invention

The present invention relates to a motor which is disposed in a vehicle, and more particularly, to a brushless direct current (BLDC) motor which is disposed in a fuel pump.

2. Description of the Related Art

Vehicles are typically propelled using power from an engine, and a gas mixture in which fuel and air are properly mixed and fed to the engine in order to actuate the pistons within an engine Typically, a fuel tank is disposed inside the rear lower section of the vehicle apart from the engine, and fuel is pumped to the engine under a suitable level of pressure. The fuel tank is provided with a fuel motor which can pump fuel to the engine. The fuel motor is implemented as a direct current (DC) motor. However, the durability of the DC motor is not very good. For example, the brush suffers from wear when the flow rate or pressure of the pump is increased via rectification through contact between the brush and a commutator, and thus must be frequently replaced. Therefore, a brushless direct current (BLDC) motor in which a brush and a commutator are not present is used. Although the BLDC motor is highly efficient and its performance can be easily improved, the BLDC motor is problematic in that it is fairly cost prohibitive because it includes a magnet that is made of expensive rare earth metal.

FIG. 1 is a cross-sectional view showing a BLDC motor of the related art, FIG. 2 is a cross-sectional view taken in line A-A in FIG. 1, and FIG. 3 is a perspective view showing the rotor of the BLDC motor of the related art. In the related art, a core is injection-molded on the shaft 100 such that an encapsulation is formed around the shaft 100, N poles 310 and S poles 330 of a rare earth metal magnet 300 are inserted into the encapsulation such that each N pole 310 alternates with each S pole 330, and then a cover is wrapped on the resultant structure, thereby completing fabrication of the motor.

Therefore, as shown in FIG. 1, an air gap AG having a certain size is continuously formed between a stator and a rotor 1000. The air gap refers to a distance between the stator and the rotor, and the permeability of the air is much smaller than that of a magnetic material (iron). Therefore, the greater this distance is, the more difficult it becomes for magnetic field lines to pass through the air gap, thereby degrading the performance of the motor.

More recently, a permanent magnet having a cylinder like configuration is buried in a core in order to minimize the air gap of a rotor. Caps are respectively fixed to the upper and lower portions of the permanent magnet in order to prevent the magnet from being dislodged during rotation, and cap dislodgement preventing members are respectively pressed into and fixed to the upper and lower portions of the caps. However, this approach results in a complicated process and involves much time and cost to build, thus is problematic.

Therefore, it is required to provide a BLDC motor which has a simple structure, is inexpensive, and has excellent performance, and which can be applied to a small-medium size vehicle or a small-medium size engine.

The information disclosed in the Background of the Invention section is only for the enhancement of understanding of the background of the invention, and should not be taken as an acknowledgment or any form of suggestion that this information forms a prior art that would already be known to a person skilled in the art.

### SUMMARY OF THE INVENTION

Accordingly, the present invention has been made keeping in mind the above problems occurring in the related art, and the present invention is intended to propose a brushless direct current (BLDC) motor which has a simple structure, is cost efficient to build, and exhibits high performance, and which can be applied to a small-medium size vehicle or a small-medium size engine

In order to achieve the above object, according to one aspect of the present invention, there is provided a brushless direct current (BLDC) motor that includes a magnet, fixing caps and a center ring. The magnet includes N poles and S poles extending in an up-down direction. The N poles and S poles are arranged so as to alternate with each other, surround an exterior of a shaft, and have a cylindrical shape when assembled. The magnet has upper and lower tapered portions in upper and lower portions thereof, the upper and lower tapered portions narrowing in the direction toward opposite ends, and a fixing center groove in the middle thereof. The fixing caps respectively have inclined portions at positions corresponding to the upper and lower tapered portions of the magnet such that the tapered portions can be fitted into the inclined portions, thereby fixing an axial position of the magnet. The center ring is fitted into the center groove of the magnet in order to prevent the magnet from being dislodged while a rotor is rotating.

In some exemplary embodiments of the present invention, the magnet may be made of ferrite. Additionally, each of the fixing caps may be cover-shaped so as to surround an upper or lower surface of the magnet from above or below. Each of the fixing caps may have a through-aperture in a central portion thereof. The through-aperture is coaxial with the shaft such that the shaft is fitted thereinto. Each of the fixing caps may also have a protrusion which is formed around the through-aperture and extends inward in the lengthwise direction of the shaft. The protrusion may be fitted between the shaft and the magnet when being fitted coupled with the magnet Each of the fixing caps may have the shape of an O-ring which surrounds a circumferential portion of the upper or lower surface of the magnet such that the fixing caps are coaxial with the shaft. The fixing caps at upper and lower positions may also have the same shape. The fixing caps may be injection-molded. The center ring may be C-shaped, and be assembled to the magnet as a separate piece, and may be injection-molded as well.

In the BLDC motor according to the exemplary embodiment of the present invention, the cost is reduced by employing the inexpensive ferrite magnet so that the motor can be applied to a small-medium size vehicle or a small-medium size engine. Since the unnecessary components are excluded, the structure and the assembly process are simplified, and desirable performance can be realized as well. Therefore, the advantage is that the BLDC motor can be extensively applied to a fuel pump control system that has a variable fuel pressure.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a cross-sectional view showing a BLDC motor of the related art;

FIG. 2 is a cross-sectional view taken in line A-A in FIG. 1;

FIG. 3 is a perspective view showing the rotor of the BLDC motor of the related art;

FIG. 4 is a cross-sectional view showing a BLDC motor according to an exemplary embodiment of the invention;

FIG. 5 is a perspective view showing the rotor of the BLDC motor shown in FIG. 4;

FIG. 6 is a cross-sectional view taken line B-B in FIG. 5;

FIG. 7 is a cross-sectional view taken line B-B in FIG. 5, showing another exemplary embodiment of the invention;

FIG. 8 is a perspective view showing the shape of the magnet before being assembled;

FIG. 9 is a perspective view showing the shape of the magnet after having been assembled;

FIG. 10 is a detailed view showing the taper portions and the center aperture of the magnet; and

FIG. 11 is an assembled view of FIG. 4.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Reference will now be made in greater detail to preferred embodiments of a brushless direct current (BLDC) motor according to the invention, examples of which are illustrated in the accompanying drawings.

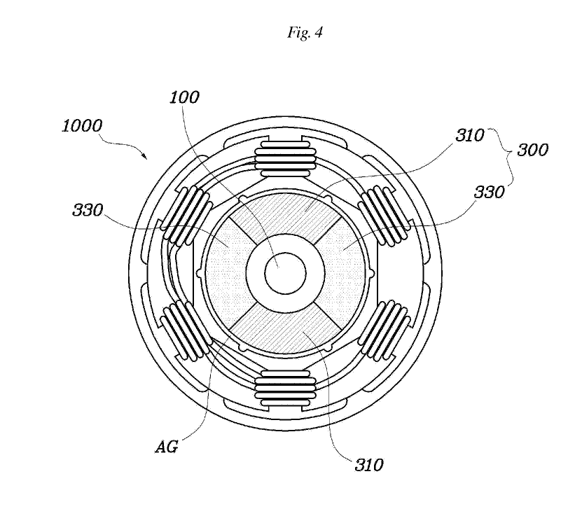

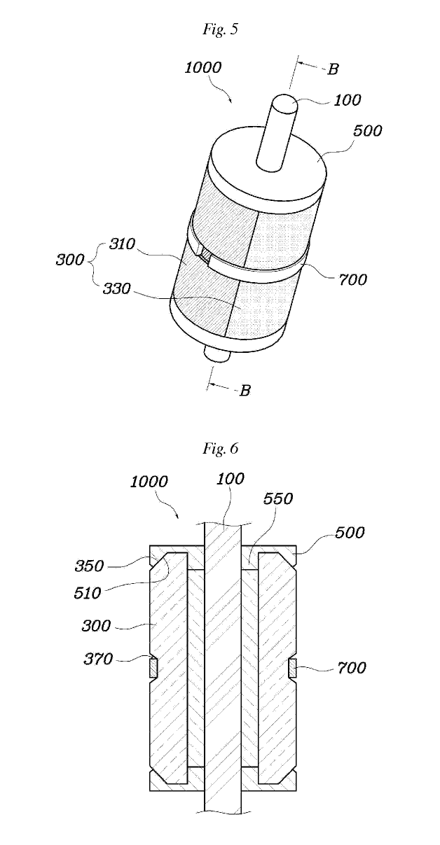

FIG. 4 is a cross-sectional view showing a BLDC motor according to an embodiment of the invention, FIG. 5 is a perspective view showing the rotor of the BLDC motor shown in FIG. 4, and FIG. 6 is a cross-sectional view taken line B-B in FIG. 5.

The BLDC motor according to this exemplary embodiment includes a magnet 300, fixing caps 500 and a center ring 700. The magnet 300 includes N poles 310 and S poles 330 which extend in the up-down direction, are arranged such that each N pole 310 alternates with each S pole 330, surround the exterior of a shaft 100, and have a cylindrical shape when assembled. The tapered portions 350 are formed in the upper and lower portions of the magnet 300 such that the diameter decreases in opposite directions toward opposite ends respectively. A fixing center groove 370 is formed in the middle of the magnet 300. The fixing caps 500 respectively have inclined portions 510 at positions corresponding to the upper and lower tapered portions 350 of the magnet 300 such that the tapered portions 350 can be fitted into the inclined portions 510, thereby fixing the axial position of the magnet 300. The center ring 700 is fitted into the center groove 370 of the magnet 300 in order to prevent the magnet 300 from being dislodged while a rotor 1000 is rotating.

More specifically, a ferrite magnet 300 is used instead of the existing rare earth magnet. In the ferrite magnet 300, the N poles 310 and the S poles 330 are respectively shaped as plates, and are then bent to have a predetermined curvature. The bent N and S poles 310 and 330 are assembled together by arranging them so as to alternate with each other while surrounding the exterior of the shaft 100. Since the core is bonded to the shaft 100, the magnet 300 surrounds the exterior of the core. The magnet 300 is formed to be longer than the core, and has the shape of a cylinder when completely assembled. The upper and lower portions of the magnet 300 beyond the core are hollow.

The upper and lower portions of the magnet 300 become gradually narrower in the direction toward the opposite ends thereof, thereby forming the tapered portions 350. The tapered portions 350 are fitted into the fixing caps 500. Each fixing cap 500 has the shape of a cover which surrounds the upper or lower surface of the magnet 300 from above or below. The cover has a circular base surface and a flange which is erected from the base surface along the circumference. The diameter of the inner surface of the flange gradually decreases in the direction toward the base surface, thereby forming the inclined portion 510. The shape of the inclined portions 510 corresponds to that of the tapered portions 350.

A through-aperture 530 is formed in the central portion of the fixing cap 500 and is coaxial with the shaft 100 such that the shaft 100 is fitted into the fixing caps 500. A protrusion 550 is formed around the through-aperture 530, extends inward from the fixing cap 500 in the lengthwise direction of the shaft 100, and has the shape of a hollow cylinder. When the fixing caps 500 are coupled with the magnet 300, the protrusions 550 are fitted around the portions of the shaft 100 that are beyond the core, i.e. into the spaces between the shaft 100 and the magnet 300, thereby facilitating the fixing.

In addition, according to another exemplary embodiment of the present invention, each fixing cap 500 may have the shape of an O-ring which is coaxial with the shaft 100 and surrounds the upper or lower cylindrical portion of the magnet 300. The upper and lower fixing caps 500 may have the same shape, and may be fitted around the upper and lower portions of the magnet 300. The fixing caps 500 can be manufactured as separate pieces, which are intended to be fitted around the magnet, or be injection-molded.

The center ring 700 is coupled to the center groove 370 which is formed in the middle of the magnet 300 along the circumference of the magnet 300. The center ring 700 is C-shaped, and can be assembled as a separate piece or be injection-molded.

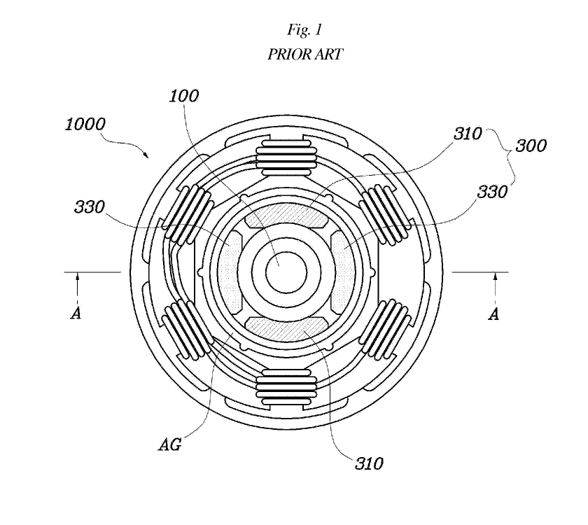

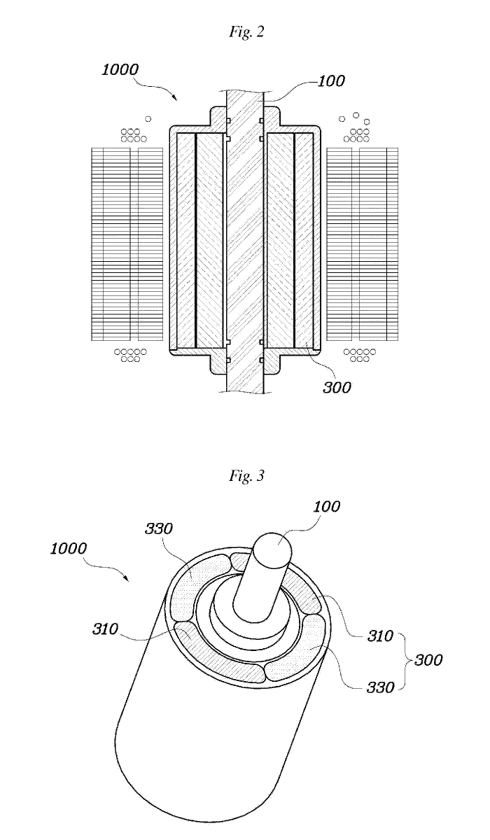

Referring to FIG. 4, the air gap AG is removed more than in FIG. 1. Here, the size of the magnet is maximized in order to compensate for the degraded performance of the magnet 300 as the magnet 300 is made of ferrite instead of a rare earth material. In addition, the encapsulation to which the magnet was assembled in the related art is also removed in order to increase the size of the magnet as much as possible. Therefore, the size of the magnet is increased compared to the magnet in the related art, whereas the air gap is decreased compared to the air gap in the related art.

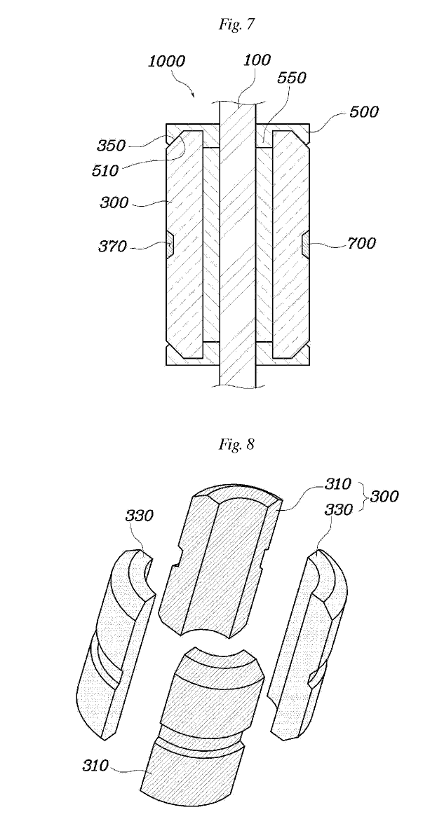

FIG. 7 is a cross-sectional view taken line B-B in FIG. 5, showing another embodiment of the invention, in which the center ring 700 is injection-molded into the center groove 370, thereby removing any gap between the center ring 700 and the magnet 300.

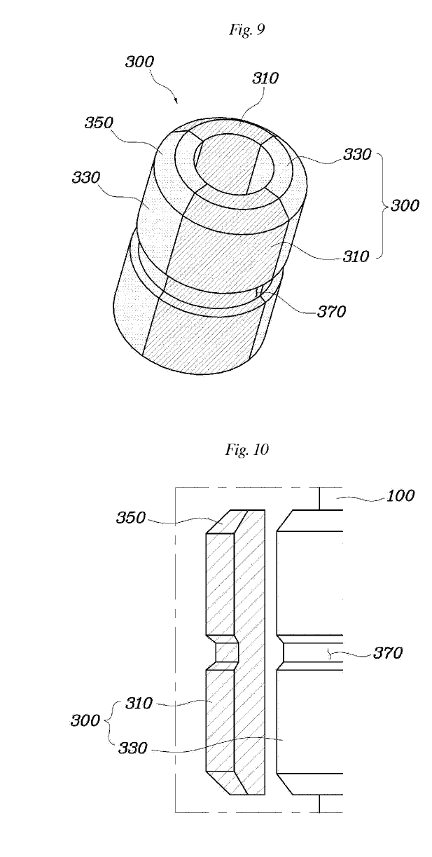

FIG. 8 is a perspective view showing the shape of the magnet 300 before being assembled, and FIG. 9 is a perspective view showing the shape after the magnet 300 in FIG. 8 has been assembled. As shown in FIG. 8 and FIG. 9, the magnet 300 is assembled by arranging the N poles 310 and the S poles 330 so as to alternate with each other.

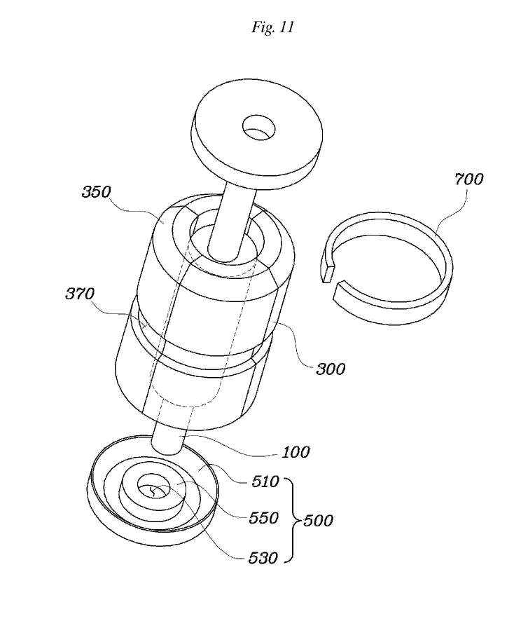

FIG. 10 is a detailed view showing the taper portions 350 and the center aperture 370 of the magnet 300. As shown in FIG. 10, the tapered portions 350 are formed in upper and lower portions of the magnet 300, and the center aperture 370 is engraved along the circumference of the magnet 300 in the middle of the magnet 30.

FIG. 11 is an assembled view of FIG. 4. As shown in FIG. 11, the core shorter than the shaft 100 is provided around the shaft 100, and the magnet 300 longer than the core is provided around the core. The tapered portions 350 are formed on the upper and lower portions of the magnet 300. The fixing caps 500 are fitted around the upper and lower portions of the shaft 100. The inclined portions 510 are respectively formed on the circumferential inner portions of the fixing caps 500, specifically, on the surfaces that correspond to the tapered portions 350 of the magnet The through-apertures 530 are respectively formed in the fixing caps 500 so as to be coaxial with the shaft 100 such that the shaft 100 can be fitted into the through-apertures 530. The protrusions 550 are respectively formed around the through-apertures and extend inward so that the protrusions are fitted into the hollow spaces between the shaft 100 and the magnet 300 when the fixing caps 500 are coupled with the magnet 300, thereby enhancing the fixing.

In the BLDC motor according to the exemplary embodiment of the invention, the cost is reduced by employing the inexpensive ferrite magnet so that the motor can be applied to a small-medium size vehicle or a small-medium size engine Since the unnecessary components of the related art are excluded, the structure and the assembly process are simplified, and desirable performance can be realized as well. Therefore, the advantage is that the BLDC motor can be extensively applied to a fuel pump control system that has a variable fuel pressure.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A brushless direct current motor comprising:
a magnet including N poles and S poles extending in an up-down direction, wherein the N poles and S poles are arranged so as to alternate with each other, surround an exterior of a shaft, and have a cylindrical shape when assembled, wherein the magnet has upper and lower tapered portions in upper and lower portions thereof, the upper and lower tapered portions narrowing in a direction toward opposite ends, and a fixing center groove disposed in a middle thereof;
fixing caps respectively having inclined portions at positions corresponding to the upper and lower tapered portions of the magnet so that the tapered portions fit into the inclined portions, thereby fixing an axial position of the magnet; and
a center ring fitted into the center groove of the magnet to prevent the magnet from being dislodged while a rotor is rotating.

2. The brushless direct current motor of claim 1, wherein the magnet is made of ferrite.

3. The brushless direct current motor of claim 1, wherein each of the fixing caps is cover-shaped to surround an upper or lower surface of the magnet from above or below, and has a through-aperture in a central portion thereof, the through-aperture being coaxial with the shaft so that the shaft is fitted thereinto, and a protrusion which is formed around the through-aperture and extends inward in a lengthwise direction of the shaft, the protrusion being fitted between the shaft and the magnet when being fitted coupled with the magnet

4. The brushless direct current motor of claim 1, wherein each of the fixing caps has a shape of an O-ring which surrounds a circumferential portion of the upper or lower surface of the magnet such that the fixing caps are coaxial with the shaft.

5. The brushless direct current motor of claim 1, wherein the fixing caps at upper and lower positions have a similar shape.

6. The brushless direct current motor of claim 1, wherein the fixing caps are injection-molded.

7. The brushless direct current motor of claim 1, wherein the center ring is C-shaped, and is assembled to the magnet as a separate piece.

8. The brushless direct current motor of claim 1, wherein the center ring is injection-molded.
